(19) United States
(12) Patent Application Publication
(10) Pub. No.: US 2002/0039231 A1
(43) Pub. Date: Apr. 4, 2002

(54) Complex grating for compensating non-uniform angular dispersion

(75) Inventor: Ilan Sela, Haifa (IL)

Correspondence Address: DARBY & DARBY, 805 THIRD AVENUE, 27TH FLR., NEW YORK, NY, 10022, US

(73) Assignee: Optichrom Inc.

(21) Appl. No.: 09/899,751

(22) Filed: Jul. 2, 2001

Related U.S. Application Data
(60) Provisional application No. 60/224,543, filed on Aug. 11, 2000.

(51) Int. Cl. G02B 5/18; G02B 27/42; G02B 27/44

(52) U.S. Cl. 359/566; 359/558

(57) ABSTRACT

A complex diffraction grating system having at least two diffraction gratings that are located adjacent to and at an angle relative to each other. The characteristics of the system may be selected so as to reduce non-linear dispersion and to provide generally constant angular dispersion at high diffraction angles.

This application claims the benefit of provisional application Ser. No. 60/224,543, filed Aug. 11, 2000, entitled “Complex Grating For Compensating Non-Uniform Angular Dispersion,” which is incorporated by reference in its entirety.

### BACKGROUND OF THE INVENTION

1. Field of Invention

The invention relates to diffraction grating systems. More particularly, the invention relates to diffraction grating systems utilized in optical devices that observe, measure or record light.

2. Description of Related Art

One of the most common methods of dispersing light uses a diffraction grating. For example, diffraction gratings are often used to observe and measure the spectrum components of light, such as by a spectroscope.

The known formula for the diffraction of light by a diffraction grating is:

nλ=d( sin θ+sin D) (1)

Where:

n is an integer corresponding to the order number;

λ is the wavelength of the incident light;

d is the spacing between the grooves on the diffraction grating;

θ is the incident angle of light on the diffraction grating with respect to the surface grating normal;

D is the diffraction angle of the light with respect to the surface grating normal.

The diffraction angle D is

D=sin⁻¹[nλd−sin θ] (1a)

The angular dispersion of the grating is given by

δD/δλ=n/(d cos D)=( sin θ+sin D)/(λcos D) (2)

by substituting for n from equation 1.

Thus, the diffraction angle of the grating depends upon the incident angle, the grating spacing, and the operating wavelength, and the angular dispersion of the grating depends on the incident angle, the diffraction angle, the grating spacing, and the wavelength.

For the purpose of minimizing or optimizing the size or configuration of the imaging optics it is desirable to operate at high diffraction angles. Additionally, for similar reasons, it may also be desirable to operate at high incident angles. In addition, the resolving power of the grating is dependent upon the number of grooves illuminated, given by the equation

R=Nn (3)

Where:

N is the number of illuminated grooves

n is an integer corresponding to the order number

Thus, for a given diffraction grating, it may be desirable to decrease the grating spacing, thereby increasing the total number of grooves on the grating and increasing the resolving power.

However, there may be disadvantages to this. As diffraction angle and incident angle increase and/or grating spacing decreases, angular dispersion increases. This is particularly true regarding diffraction angle. As the wavelength increases and/or grating spacing decreases, the diffraction angle increases. Further, at high diffraction angles the dispersion, as a function of wavelength, is strongly nonlinear. As the diffraction angle approaches π/2(90°), the angular dispersion increases toward infinity, and the diffraction angle difference between constantly spaced wavelengths rapidly diverges.

This phenomenon creates known problems in a spectrometer and other dispersion or detection devices in which the photonic flow is measured as a function of the wavelength. In the case of a spectrograph with detector array, the arrays must be designed specifically to accommodate the nonlinear dispersion angle. In the case of a monochromator, the grating rotating mechanism must be designed to accommodate for the nonlinear dispersion angle.

In wavelength division multiplexing (WDM) and Dense WDM (DWDM) applications, the Multiplex/Dense Multiplex (Mux/Demux) devices resemble a spectrograph, but instead of the detector array, a fiber bundle or waveguide array is used. Compensating for the nonlinear dispersion angle requires utilizing subsequent fibers with gradually increasing clad diameter or utilizing an optical waveguide with increasing distance between the waveguide channels. However, this solution will not accommodate the increase in the channel bandwidth, resulting in coupling losses, which increase towards shorter wavelengths.

Another option to avoid the nonlinear diffraction regime is to operate at a lower diffraction angle. This may be accomplished using large focal-length imaging optics. While large optics increase resolving power by increasing the total number of illuminated grooves, this may undesirably increase the size and cost of the system. For WDM and DWDM applications, the permissible size of the component is limited and a much smaller spectrometer is required.

It would be desirable to provide a diffraction grating system that provides more linear dispersion of light and more constant angular dispersion. It would also be desirable to provide a diffraction grating system that permits high diffraction angles without large, non-linear dispersions.

### SUMMARY OF THE INVENTION

It is an object of the invention to provide a diffraction grating system having high resolving power and high diffraction angles with near constant angular dispersion as a function of the wavelength.

It is another object of the invention to provide a diffraction grating system having high diffraction angles without large and non-linear dispersion of light.

The present invention comprises a complex diffraction grating system having at least two diffraction gratings. The gratings are located adjacent to and at an angle relative to each other. The optical characteristics of the gratings and the angle may be selected to reduce non-linear dispersion of light by the present system as compared to known systems. The characteristics and angle may be selected so as to provide a system having generally constant angular dispersion at high diffraction angles.

### BRIEF DESCRIPTION OF THE DRAWINGS

The foregoing and other features of the present invention will be more readily apparent from the following detailed description and drawings of one or more illustrative embodiments of the invention where like reference numbers refer to similar elements throughout the several views and in which:

FIG. 1 is a complex diffraction grating according to an embodiment of the present invention;

FIG. 2 is graph showing the angular dispersion of a parallel diffraction grating system and the angular dispersion of a complex diffraction grating according to an embodiment of the present invention; and

FIG. 3 is a graph showing the angular dispersion of a single diffraction grating system and the angular dispersion of a complex diffraction grating according to an embodiment of the present invention.

### DETAILED DESCRIPTION OF THE INVENTION

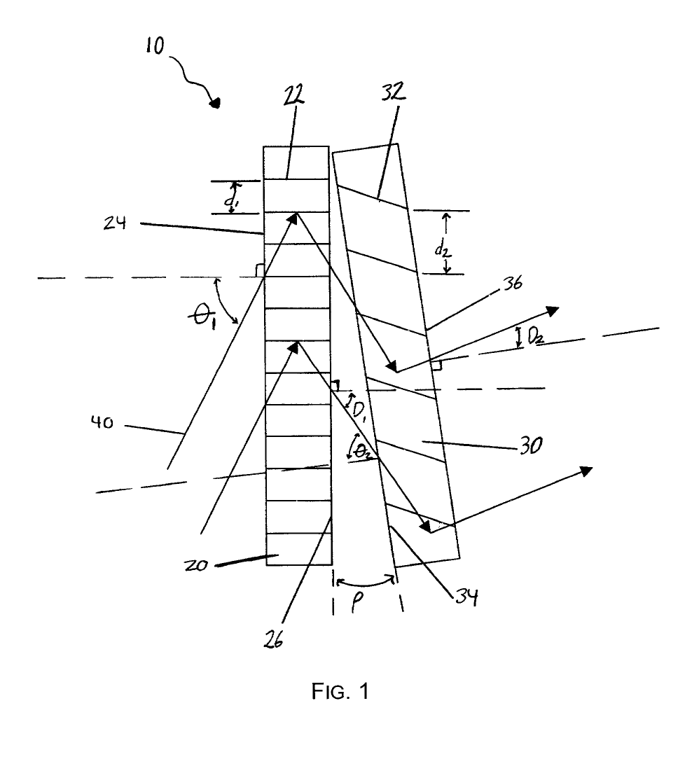

An illustrative embodiment of a diffraction grating system constructed according to the invention is shown in FIG. 1. The diffraction grating system 10 comprises of two volume phase holographic gratings 20, 30 located adjacent to each other. The first grating 20 may have parallel grooves 22, as is known in the art, with a spacing d₁ between the grooves 22. The second grating 30 may also have parallel grooves 32 with a spacing d₂ between them. The second grating 30 may be located so that light 40 passing through the first grating 20 also passes through the second grating 30. The second grating 30 may also be oriented at an angle ρ in relation to the first grating 20. The angle ρ may be zero or greater.

When the light beam 40 contacts the first grating 20 at an angle θ₁ with respect to the normal (perpendicular) to the incident surface 24 of the first grating 20, it is diffracted at a diffraction angle D₁ with respect to the normal to the exit surface 26 of the first grating 20. If the second grating 30 is appropriately arranged, the light beam 40 then contacts the second grating 30 at an angle θ₂ with respect to the normal to the incident surface 34 of the second grating 30. It is diffracted by the grating 30 at a diffraction angle D₂ with respect to the normal to the exit surface 36 of the second grating 30.

The difraction characteristics of the grating system 10 may be determined as follows. For the first grating 20:

nλ=d₁( sin θ₁+sin D₁) (4)

For the second grating 30:

mλ=d₂( sin (D₁+ρ)+sin (D₂))=d₂( sin (D₁) cos (ρ)+sin (ρ) cos (D₁)+sin (D₂)) (5)

Where:

n and m are integers corresponding to the order number

Equation 4 may also be expressed as follow:

sin (D₁)−nλ/d₁−sin (θ₁) (6)

The factor “sin (D₁)” from equation 6 can be substituted into equation 5 to obtain the following result:

mλ=d₂[(nλ/d₁−sin (θ₁)) cos (ρ)+sin (ρ) (l−(nλ/d−sin (θ₁))²)^{½}+sin (D₂)] (7)

Thus, the diffraction angle D₂ of the grating system 10 is:

D₂=sin^{-1[}mλ/d₂ −(nλ/d₁−sin (θ₁)) cos (ρ)−sin (ρ)(l−(nλ/d₁−sin (θ₁))²)^{½}] (7a)

Using equation 7, the angular dispersion of the grating system 10 is:

δD/δλ=[(m/d₂−cos (ρ)n/d₁)+Xn sin (ρ)/(d₁(l−X²) ^{½})]/cos (D₂) (8)

where

X=λn/d₁−sin (θ₁) (9)

As can be seen from equation 8, the angular dispersion of the grating system 10 is dependent, among other things, upon the factor “1/cosD₂,” i.e., the denominator. As discussed above, this factor becomes larger as D₂ approaches π/2, and consequently, the angular dispersion becomes larger at high diffraction angles. Moreover, as also discussed above and demonstrated by equation 8, the angular dispersion of the grating system 10 is dependent on wavelength, through D₂ in equation 7a and X in equation 9. In other words, neither the numerator nor the denominator of equation 8 is a constant as a function of wavelength. The result is that in a complex diffraction grating system, the angular dispersion may not be near constant, resulting in non-linear dispersion and the disadvantages that are described above.

However, in accordance with the invention, the characteristics and/or parameters of the grating sytem 10 may be selected so that the angular dispersion is more constant. That is, n, m, d_{1, θhd 1,} d₂ and ρ may be selected so that the numerator of equation 8 compensates for the denominator, 1/cos (D₂), so that the resulting angular dispersion is more constant as a function of wavelength. Preferably, the charactertics and/or parameters are selected so as compensate for the 1/cos (D₂) factor as much as possible, thereby causing the angular dispersion to be as constant as possible. In this manner, the detection device to observe or measure the light spectra may be constructed with as small a size and cost as possible.

Those skilled in the art should appreciate that the selection of certain characteristics and parameters of the system 10 may be influenced by considerations other than angular dispersion. For example, as previously discussed, considerations of the size of the detection equipment may require a certain, e.g., high, diffraction angle D₂ or desired incidence angle θ₁. Thus, the incidence angle θ₁ of the light 40, the spacing di of the grooves 22 of the first grating 20, and/or the spacing d₂ of the grooves 32 of the second grating 30 may be selected in accordance with these factors. By way of another example, the spacings d₁, d₂ of the grooves 22, 32 may be selected in order to obtain a desired resolving power of the grating system 10.

The followings examples are illustrative of the invention without being limiting thereto.

### EXAMPLE 1

In an illustrative embodiment of the invention, the diffraction grating system 10 has the following parameters:

| | |
|---|---|
| n = 1 | m = 1 |
| d₁ = 0.81 microns | d₂ = 8 microns |
| θ₁ = 1.24 radians | ρ = 0.03295 radians |

The characteristics of this system over an exemplary range of wavelengths is provided in TABLE 1.

TABLE 1

| Wavelengh | Diffraction Angle | Angular Dispersion |
|---|---|---|
| (microns) | (radians) | (radians/nanometer) |
| 1.5200 | 0.8515 | 0.001526 |
| 1.5216 | 0.8540 | 0.001528 |
| 1.5232 | 0.8564 | 0.001529 |
| 1.5248 | 0.8589 | 0.001531 |
| 1.5264 | 0.8613 | 0.001532 |
| 1.5280 | 0.8638 | 0.001534 |
| 1.5296 | 0.8662 | 0.001535 |
| 1.5312 | 0.8687 | 0.001536 |
| 1.5328 | 0.8712 | 0.001537 |
| 1.5344 | 0.8736 | 0.001537 |
| 1.5360 | 0.8761 | 0.001538 |
| 1.5376 | 0.8785 | 0.001538 |
| 1.5392 | 0.8810 | 0.001538 |
| 1.5408 | 0.8835 | 0.001538 |
| 1.5424 | 0.8859 | 0.001537 |
| 1.5440 | 0.8884 | 0.001536 |
| 1.5456 | 0.8908 | 0.001535 |
| 1.5472 | 0.8933 | 0.001533 |
| 1.5488 | 0.8957 | 0.001530 |

From TABLE 1, it should be apparent to those skilled in the art that the above described embodiment of the invention provides a diffraction grating system that has relatively constant angular dispersion, with high diffraction angles. Thus, the advantages of such a system, as described earlier herein, may be utilized without the disadvantages of non-linear dispersion.

On the other hand, in a system where the diffraction gratings have the characteristics of those in EXAMPLE 1, but, for example, the angle ρ=0, i.e., the gratings are parallel, the dispersion is highly non-linear. In such an instance, the diffraction characteristics of such a system, as given by equation 7, would be:

λ(m/d₂₋n/d₁)=sin (D₂)−sin (θ₁) (10)

For m=n=1, this would provide an effective grating with and effective groove spacing of d₂d₁/(d₁-d₂).

The angular dispersion, as given by equation 8, would be

δD/δλ=(m/d₂₋n/d₂)/ cos (D₂) (1)

In such a system, the angular dispersion is wholy dependent upon “cos (D₂),” and there is no compensation for non-linearity, as is demonstrated by TABLE 2, providing the characteristics of a parallel system.

TABLE 2

| Wavelengh | Diffraction Angle | Angular Dispersion |
|---|---|---|
| (Microns) | (radians) | (radians/nanometer) |
| 1.5200 | 0.8342 | 0.001652 |
| 1.5216 | 0.8368 | 0.001657 |
| 1.5232 | 0.8395 | 0.001661 |
| 1.5248 | 0.8422 | 0.001666 |
| 1.5264 | 0.8448 | 0.001671 |
| 1.5280 | 0.8475 | 0.001676 |
| 1.5296 | 0.8502 | 0.001682 |
| 1.5312 | 0.8529 | 0.001687 |
| 1.5328 | 0.8556 | 0.001692 |
| 1.5344 | 0.8583 | 0.001697 |
| 1.5360 | 0.8610 | 0.001703 |
| 1.5376 | 0.8638 | 0.001708 |
| 1.5392 | 0.8665 | 0.001714 |
| 1.5408 | 0.8692 | 0.001719 |
| 1.5424 | 0.8720 | 0.001725 |
| 1.5440 | 0.8748 | 0001731 |
| 1.5456 | 0.8775 | 0.001736 |
| 1.5472 | 0.8803 | 0.001742 |
| 1.5488 | 0.8831 | 0.001748 |

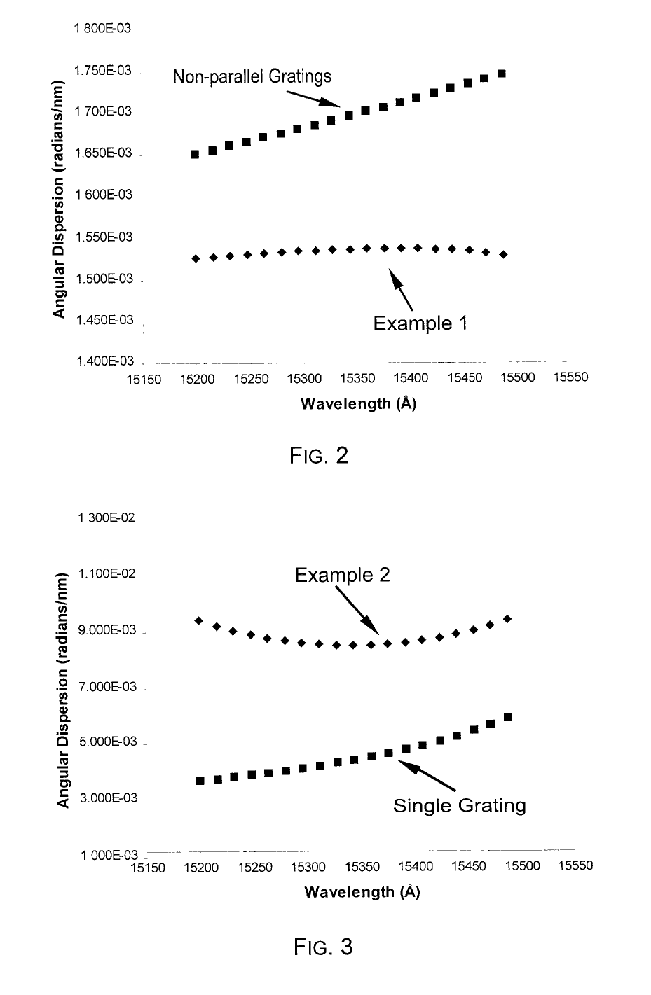

As shown by TABLE 2, the parallel system provides similar diffraction angles to the embodiment of the invention discussed in EXAMPLE 1, but has sharply increasing, that is, non-constant, angular dispersion. The difference between EXAMPLE 1 of the invention and a parallel grating system is further demonstated by FIG. 2, which presents a graph of the angular dispersions of EXAMPLE 1 and the parallel grating structure.

Those skilled in the art should realize that, in embodiments of the invention where the characteristics of the gratings 20, 30 are at least partially selected based on criteria other than angular dispersion, e.g., resolving power, diffraction angle/size considerations, the angle ρ becomes critical to achieving a more linear dispersion.

### EXAMPLE 2

n=1

m=1

d₁₌0.798 microns

d₂₌1.568 microns

θ₁₌1.3 radians

ρ=−1.201 radians

The characteristics of this system over a range of exemplary wavelengths is provided in TABLE 3.

TABLE 3

| Wavelengh | Diffraction Angle | Angular Dispersion |
|---|---|---|
| (Microns) | (radians) | (radians/nanometer) |
| 1.5200 | 1.2386 | 0.00941 |
| 1.5216 | 1.2237 | 0.00921 |
| 1.5232 | 1.2091 | 0.00904 |
| 1.5248 | 1.1947 | 0.00890 |
| 1.5264 | 1.1806 | 0.00878 |
| 1.5280 | 1.1666 | 0.00869 |
| 1.5296 | 1.1528 | 0.00862 |
| 1.5312 | 1.1390 | 0.00857 |
| 1.5328 | 1.1253 | 0.00854 |
| 1.5344 | 1.1117 | 0.00853 |
| 1.5360 | 1.0980 | 0.00854 |
| 1.5376 | 1.0843 | 0.00857 |
| 1.5392 | 1.0706 | 0.00862 |
| 1.5408 | 1.0567 | 0.00868 |
| 1.5424 | 1.0428 | 0.00877 |
| 1.5440 | 1.0286 | 0.00889 |
| 1.5456 | 1.0143 | 0.00903 |
| 1.5472 | 0.9997 | 0.00920 |
| 1.5488 | 0.9848 | 0.00941 |

TABLE 3 again demonstrates that the invention advantageously provides a diffraction grating system with high diffraction angles and relatively linear angular dispersion.

In comparison, Table 4 presents the characteristics of a system having a single grating similar to the first grating 20 in EXAMPLE 2 when exposed to the same wavelengths of light at the same incident angle (n=1, m=1, d₁₌0.798 microns, θ₁₌1.3 radians).

TABLE 4

| Wavelengh | Diffraction Angle | Angular Dispersion |
|---|---|---|
| (microns) | (radians) | (radians/nanometer) |
| 1.5200 | 1.2262 | 0.00371 |
| 1.5216 | 1.2322 | 0.00377 |
| 1.5232 | 1.2382 | 0.00384 |
| 1.5248 | 1.2444 | 0.00391 |
| 1.5264 | 1.2508 | 0.00398 |
| 1.5280 | 1.2572 | 0.00406 |
| 1.5296 | 1.2638 | 0.00415 |
| 1.5312 | 1.2705 | 0.00424 |
| 1.5328 | 1.2773 | 0.00433 |
| 1.5344 | 1.2843 | 0.00443 |
| 1.5360 | 1.2915 | 0.00455 |
| 1.5376 | 1.2989 | 0.00467 |
| 1.5392 | 1.3065 | 0.00480 |
| 1.5408 | 1.3142 | 0.00494 |
| 1.5424 | 1.3223 | 0.00509 |
| 1.5440 | 1.3305 | 0.00527 |
| 1.5456 | 1.3391 | 0.00546 |
| 1.5472 | 1.3480 | 0.00567 |
| 1.5488 | 1.3573 | 0.00591 |

While the single grating system, like the double grating system of the invention, provides high diffraction angles, which may be desirable, those skilled in the art will clearly see that the invention provides not only more constant angular dispersion, but also, angular dispersion that is generally much larger than the single grating system. This difference is also demonstated by FIG. 3, which presents a graph of the angular dispersions of EXAMPLE 2 and the single grating structure. The larger angular dispersion provided by the invention supplies an advantage over known single grating systems in that a smaller spectrometer may be used, which decreases both cost and space requirements.

Accordingly, the present invention provides diffraction grating systems having more linear dispersions and more contstant angular dispersions as compared to previously known systems. The invention also provides such systems for use with high diffraction angles so that size and cost advantages thereof may be utilized. The invention further permits such systems to be designed according to particular criteria, such as, for example, desired resolving power.

While the embodiments of the invention shown and described herein are fully capable of achieving the results desired, it is to be understood that these embodiments have been shown and described for purposes of illustration only and not for purposes of limitation. Other variations in the form and details of the invention that occur to those skilled in the art and are within the spirit and scope of the invention may not be specifically addressed, but the claimed invention is limited only by the appended claims.

I claim:

1. A light diffraction grating system comprising:
a first and second diffraction grating each having grooves thereon, said first diffraction grating having a first set of characteristics and said second diffraction grating having a second set of characteristics,
said second diffraction grating being oriented at an angle to said first diffraction grating,
said first and second sets of charcteristics and said angle being selected so as to reduce non-linear dispersion of light by said system.

2. The system of claim 1, wherein said first and second sets of characteristics include spacing between said grooves.

3. The system of claim 1, wherein said angle is greater than zero.

4. The system of claim 1, wherein said second diffraction grating is oriented nonparallel to said first diffraction grating.

5. The system of claim 1, said first and second sets of characteristics and said angle being selected so that said dispersion is generally linear.

6. A light diffraction grating system comprising:
a first and second diffraction grating each having parallel grooves thereon, said first diffraction grating having a first set of characteristics and said second diffraction grating having a second set of characteristics,
said second diffraction grating being oriented at an angle to said first diffraction grating,
said angle being selected so as to reduce non-linear dispersion of light by said system.

7. The system of claim 6, wherein said first and second sets of characteristics include spacing between said grooves.

8. The system of claim 6, wherein said angle is greater than zero.

9. The system of claim 6, wherein said second diffraction grating is oriented nonparallel to said first diffraction grating.

10. The system of claim 6, said first and second sets of characteristics and said angle being selected so that said dispersion is generally linear.

11. A light diffraction grating system comprising a first and second diffraction grating each having parallel grooves thereon, said first and second diffraction gratings being adapted to reduce non-linear dispersion of light by said system.

12. A light diffraction grating system comprising:
a first and second diffraction grating each having parallel grooves thereon, said first diffraction grating having a first set of characteristics and said second diffraction grating having a second set of characteristics,
said second diffraction grating being oriented at an angle to said first diffraction grating,
said first and second sets of characteristics and said angle being selected so that angular disperion of said system is generally constant.

13. The system of claim 11, wherein said first and second sets of characteristics include spacing between said grooves.

14. The system of claim 11, wherein said angle is greater than zero.

15. The system of claim 11, wherein said second diffraction grating is oriented nonparallel to said first diffraction grating.

16. A light diffraction grating system comprising a first and second diffraction grating each having parallel grooves thereon, said first and second diffraction gratings being adapted so that angular disperion of said system is generally constant.

17. A light diffraction grating system comprising:
a first and second diffraction grating each having parallel grooves thereon, said first diffraction grating having a first set of characteristics and said second diffraction grating having a second set of characteristics,
said second diffraction grating being oriented at an angle to said first diffraction grating,
said angle being selected so that angular disperion of said system is generally constant.

18. The diffraction grating system of claim 17, wherein said first and second sets of characteristics include spacing between said grooves.

19. The diffraction grating system of claim 17, wherein said angle is greater than zero.

20. The diffraction grating system of claim 17, wherein said second diffraction grating is oriented nonparallel to said first diffraction grating.

21. A method of providing a light diffraction grating system having substantially linear dispersion of light thereby, comprising:
providing a first diffraction grating having parallel grooves thereon;
providing a second diffraction grating having parallel grooves thereon;
orienting said second diffraction grating at an angle to said first diffraction grating; and
selecting said angle, spacing of said grooves of said first diffraction grating, and spacing of said grooves of said second diffraction grating so as to provide said substantially linear dispersion.

22. The method of claim 21, further including providing the grooves of said first diffraction grating with a substantially constant spacing therebetween and providing the grooves of said first diffraction grating with a substantially constant spacing therebetween.

23. A method of providing a light diffraction grating system having substantially linear dispersion of light thereby, comprising:
providing a first diffraction grating having parallel grooves thereon;
providing a second diffraction grating having parallel grooves thereon;
orienting said second diffraction grating at an angle to said first diffraction grating; and
selecting said angle so as to provide said substantially linear dispersion.

24. The method of claim 22, further including providing the grooves of said first diffraction grating with a substantially constant spacing therebetween and providing the grooves of said first diffraction grating with a substantially constant spacing therebetween.

25. A method of providing a light diffraction grating system having generally constant angular dispersion, comprising:
providing a first diffraction grating having parallel grooves thereon;
providing a second diffraction grating having parallel grooves thereon;
orienting said second diffraction grating at an angle to said first diffraction grating; and
selecting said angle, spacing of said grooves of said first diffraction grating, and spacing of said grooves of said second diffraction grating so as to provide said substantially constant angular dispersion.

26. The method of claim 21, further including providing the grooves of said first diffraction grating with a substantially constant spacing therebetween and providing the grooves of said first diffraction grating with a substantially constant spacing therebetween.

27. A method of providing a light diffraction grating system having generally constant angular dispersion, comprising:
providing a first diffraction grating having parallel grooves thereon;
providing a second diffraction grating having parallel grooves thereon;
orienting said second diffraction grating at an angle to said first diffraction grating; and
selecting said angle so as to to provide said substantially constant angular dispersion.

28. The method of claim 22, further including providing the grooves of said first diffraction grating with a substantially constant spacing therebetween and providing the grooves of said first diffraction grating with a substantially constant spacing therebetween.

29. An optical detector comprising:
a complex diffraction grating having first and second diffraction gratings oriented at an angle with respect to each other so that angular dispersion of light diffracted by said complex diffraction grating is generally constant.

30. The optical detector of claim 29, further comprising a device for dectecting light diffracted by said diffraction system.

31. The optical detector of claim 29, wherein said optical detector comprises a spectrometer.

32. In an light diffraction grating system having first and second diffraction gratings, a method of providing said system with generally constant angular dispersion, comprising:
orienting said second diffraction grating at an angle with respect to said first diffraction grating so that angular dispersion of said system is generally constant.

33. In an light diffraction grating system having first and second diffraction gratings, a method of providing that dispersion of light by said system is substantially linear, comprising:
orienting said second diffraction grating at an angle with respect to said first diffraction grating so that said dispersion is substantially linear.
